(19) United States
(12) Patent Application Publication
(10) Pub. No.: US 2020/0144640 A1
(43) Pub. Date: May 7, 2020

(54) FUEL CELL SYSTEM

(71) Applicant: TOYOTA JIDOSHA KABUSHIKI KAISHA, Toyota-shi (JP)

(72) Inventors: Tomohiko KANEKO, Okazaki-shi (JP); Masayuki ITO, Sunto-gun (JP); Hideyuki KUMEI, Sunto-gun (JP)

(73) Assignee: TOYOTA JIDOSHA KABUSHIKI KAISHA, Toyota-shi (JP)

(21) Appl. No.: 16/582,287

(22) Filed: Sep. 25, 2019

(30) Foreign Application Priority Data
Nov. 2, 2018 (JP) 2018-207609

(51) Int. Cl. H01M 8/04119; H01M 8/2465; H01M 8/04828

(52) U.S. Cl. CPC H01M 8/04179; H01M 2250/20; H01M 8/04843; H01M 8/2465

(57) ABSTRACT

A fuel cell system is equipped with a first fuel cell, a second fuel cell, a scavenging device that can scavenge the first fuel cell and the second fuel cell independently of each other, and a control device configured to control the scavenging device. An electric power generation volume of the second fuel cell is smaller than an electric power generation volume of the first fuel cell. The control device is configured to scavenge the second fuel cell.

The disclosure of Japanese Patent Application No. 2018-207609 filed on Nov. 2, 2018 including the specification, drawings and abstract is incorporated herein by reference in its entirety.

### BACKGROUND

### 1. Technical Field

The disclosure relates to a fuel cell system.

### 2. Description of Related Art

There is known an art of scavenging a fuel cell with a view to draining the liquid water remaining in the fuel cell. For example, in Japanese Unexamined Patent Application Publication No. 2005-276529 (JP 2005-276529 A), one or some of a plurality of fuel cells are scavenged in a system that is equipped with the plurality of the fuel cells (e.g., see JP 2005-276529 A).

### SUMMARY

The amount of electric power consumed through such scavenging is desired to be small, but it is also necessary to sufficiently drain water from the fuel cells through scavenging.

The disclosure provides a fuel cell system that can sufficiently drain water from at least one of a plurality of fuel cells while restraining the amount of electric power consumed through scavenging from increasing.

An aspect of the disclosure relates to a fuel cell system. This fuel cell system is equipped with a first fuel cell, a second fuel cell, a scavenging device that can scavenge the first fuel cell and the second fuel cell independently of each other, and a control device configured to control the scavenging device. An electric power generation volume of the second fuel cell is smaller than an electric power generation volume of the first fuel cell. The control device is configured to scavenge the second fuel cell.

The amount of liquid water remaining in the fuel cell decreases as the electric power generation volume decreases. Therefore, the amount of electric power needed to sufficiently drain water through scavenging is smaller in the second fuel cell whose electric power generation volume is small than in the first fuel cell whose electric power generation volume is large. Accordingly, water can be sufficiently drained from the second fuel cell with a small amount of electric power consumption, by scavenging the second fuel cell.

The control device may not be configured to scavenge the first fuel cell.

The control device may be configured to scavenge the first fuel cell with an amount of electric power consumption that is smaller than an amount of electric power consumed by scavenging the second fuel cell.

The control device may be configured to scavenge the first fuel cell and the second fuel cell such that a scavenging period of the first fuel cell and a scavenging period of the second fuel cell at least partially overlap with each other.

The control device may be configured to start and complete scavenging of the first fuel cell in a period in which scavenging of the second fuel cell is carried out.

The fuel cell system may be equipped with a third fuel cell with an electric power generation volume that is larger than the electric power generation volume of the second fuel cell. The scavenging device may be able to scavenge the first fuel cell, the second fuel cell, and the third fuel cell independently of one another. The control device may not be configured to scavenge the third fuel cell.

The fuel cell system may be equipped with a third fuel cell with an electric power generation volume that is equal to the electric power generation volume of the second fuel cell. The scavenging device may be able to scavenge the first fuel cell, the second fuel cell, and the third fuel cell independently of one another. The control device may be configured to scavenge the third fuel cell.

The fuel cell system may be equipped with a third fuel cell with an electric power generation volume that is smaller than the electric power generation volume of the second fuel cell. The scavenging device may be able to scavenge the first fuel cell, the second fuel cell, and the third fuel cell independently of one another. The control device may not be configured to scavenge the third fuel cell.

Each of the first fuel cell and the second fuel cell may be equipped with a plurality of single cells. An electric power generation volume of each of the single cells may be a value obtained by multiplying an electric power generation area of each of the single cells and an electrode thickness of each of the single cells by each other. The electric power generation volume of the first fuel cell may be a sum of electric power generation volumes of the plurality of the single cells with which the first fuel cell is equipped. The electric power generation volume of the second fuel cell may be a sum of electric power generation volumes of the plurality of the single cells with which the second fuel cell is equipped. The control device may be configured to scavenge only the second fuel cell in stopping electric power generation by the first fuel cell and the second fuel cell.

A fuel cell system that can sufficiently drain water from at least one of a plurality of fuel cells while restraining the amount of electric power consumed through scavenging from increasing can be provided.

### BRIEF DESCRIPTION OF THE DRAWINGS

Features, advantages, and technical and industrial significance of an exemplary embodiment of the disclosure will be described below with reference to the accompanying drawings, in which like numerals denote like elements, and wherein:

FIG. 1 is a configuration view of a fuel cell system that is mounted in a vehicle;

FIGS. 2A and 2B are illustrative views of an electric power generation volume of a fuel cell;

FIG. 3 is a flowchart showing an example of scavenging control;

FIG. 4 is a timing chart showing an example of scavenging control;

FIG. 5 is a flowchart showing a modification example of scavenging control;

FIG. 6 is a timing chart showing the modification example of scavenging control;

FIG. 7A is a view showing three fuel cells adopted in the system;

FIG. 7B is a view showing three fuel cells adopted in the system; and

FIG. 7C is a view showing three fuel cells adopted in the system.

### DETAILED DESCRIPTION OF EMBODIMENT

Configuration of Fuel Cell System

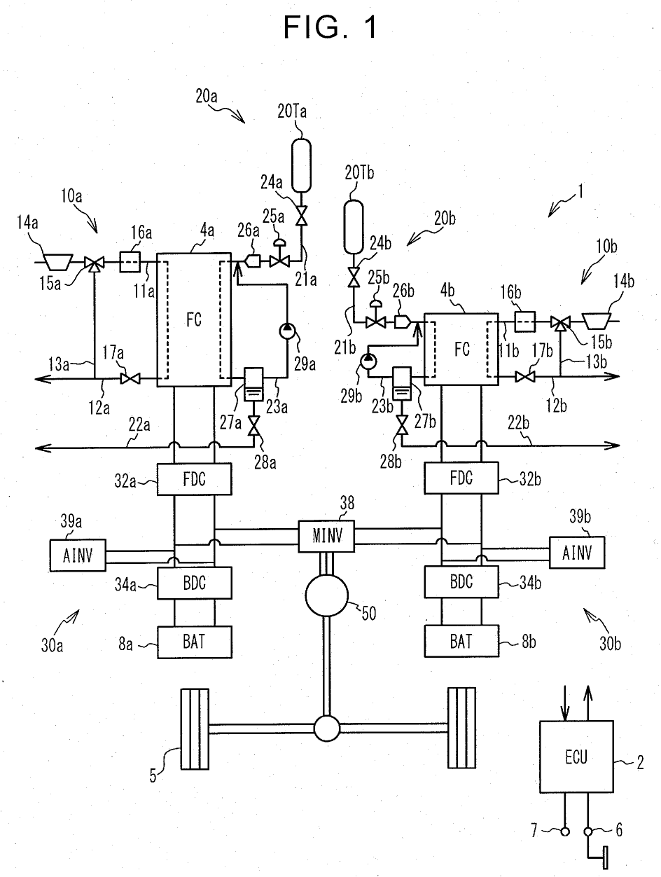

FIG. 1 is a configuration view of a fuel cell system (hereinafter referred to simply as the system) 1 that is mounted in a vehicle. The system 1 includes an electronic control unit (an ECU) 2, fuel cells (hereinafter referred to as FC's) 4a, 4b, secondary batteries (hereinafter referred to as BAT's) 8a, 8b, cathode gas supply systems 10a, 10b, anode gas supply systems 20a, 20b, electric power control systems 30a, 30b, a motor 50, and the like. The system 1 includes a cooling system (not shown) that cools the FC's 4a, 4b by circulating coolant therethrough.

Each of FC's 4a, 4b is a fuel cell that generates electric power upon being supplied with cathode gas and anode gas. Each of the FC's 4a, 4b is obtained by stacking a plurality of polyelectrolyte-type single cells. In the present embodiment, the FC 4b is smaller in size than the FC 4a, and is also smaller in rated output than the FC 4a. Specifically, both the FC's 4a, 4b are obtained by stacking the same single cells, and the number of stacked single cells in the FC 4b is smaller than the number of stacked single cells in the FC 4a. The FC 4b is smaller in electric power generation volume than the FC 4a. The FC 4a is an example of the first fuel cell, and the FC 4b is an example of the second fuel cell (Details will be described later).

The cathode gas supply systems 10a, 10b supply air containing oxygen as cathode gas to the FC's 4a, 4b respectively. Specifically, the cathode gas supply systems 10a, 10b include supply pipes 11a, 11b, exhaust pipes 12a, 12b, bypass pipes 13a, 13b, air compressors (hereinafter referred to as ACP's) 14a, 14b, bypass valves 15a, 15b, intercoolers 16a, 16b, and back pressure valves 17a, 17b respectively.

The supply pipes 11a, 11b are connected to cathode inlet manifolds of the FC's 4, 4b respectively. The exhaust pipes 12a, 12b are connected to cathode outlet manifolds of the FC's 4a, 4b respectively. The bypass pipe 13a establishes communication between the supply pipe 11a and the exhaust pipe 12a. Similarly, the bypass pipe 13b establishes communication between the supply pipe 11b and the exhaust pipe 12b. The bypass valve 15a is provided at a part where the supply pipe 11a and the bypass pipe 13a are connected. Similarly, the bypass valve 15b is provided at a part where the supply pipe 11b and the bypass pipe 13b are connected. The bypass valve 15a changes over the state of communication between the supply pipe 11a and the bypass pipe 13a. Similarly, the bypass valve 15b changes over the state of communication between the supply pipe 11b and the bypass pipe 13b. The ACP 14a, the bypass valve 15a, and the intercooler 16a are provided on the supply pipe 11a in this order from an upstream side. The back pressure valve 17a is provided on the exhaust pipe 12a on the upstream side of a part where the exhaust pipe 12a and the bypass pipe 13a are connected. Similarly, the ACP 14b, the bypass valve 15b, and the intercooler 16b are provided on the supply pipe 11b in this order from the upstream side. The back pressure valve 17b is provided on the exhaust pipe 12b on the upstream side of a part where the exhaust pipe 12b and the bypass pipe 13b are connected.

The ACP's 14a, 14b supply air containing oxygen as cathode gas to the FC's 4a, 4b via the supply pipes 11a, 11b respectively. The cathode gas supplied to the FC's 4a, 4b is discharged via the exhaust pipes 12a, 12b respectively. The intercoolers 16a, 16b cool the cathode gas supplied to the FC's 4a, 4b respectively. The back pressure valves 17a, 17b adjust back pressures of cathode sides of the FC's 4a, 4b respectively.

The anode gas supply systems 20a, 20b supply hydrogen gas as anode gas to the FC's 4a, 4b respectively. Specifically, the anode gas supply systems 20a, 20b include tanks 20Ta, 20Tb, supply pipes 21a, 21b, exhaust pipes 22a, 22b, circulation pipes 23a, 23b, tank valves 24a, 24b, pressure adjusting valves 25a, 25b, injectors (hereinafter referred to as INJ's) 26a, 26b, gas-liquid separators 27a, 27b, drain valves 28a, 28b, and hydrogen circulation pumps (hereinafter referred to as HP's) 29a, 29b respectively.

The tank 20Ta and the anode inlet manifold of the FC 4a are connected to each other by the supply pipe 21a. Similarly, the tank 20Tb and the anode inlet manifold of the FC 4b are connected to each other by the supply pipe 21b. Hydrogen gas as anode gas is stored in the tanks 20Ta, 20Tb. The exhaust pipes 22a, 22b are connected to anode outlet manifolds of the FC's 4a, 4b respectively. The circulation pipe 23a establishes communication between the gas-liquid separator 27a and the supply pipe 21a. The circulation pipe 23b establishes communication between the gas-liquid separator 27b and the supply pipe 21b. The tank valve 24a, the pressure adjusting valve 25a, the INJ 26a are provided on the supply pipe 21a in this order from an upstream side of the supply pipe 21a. With the tank valve 24a open, the opening degree of the pressure adjusting valve 25a is adjusted, and the INJ 26a injects anode gas. Thus, anode gas is supplied to the FC 4a. The driving of the tank valve 24a, the pressure adjusting valve 25a, and the INJ 26a is controlled by the ECU 2. The same applies to the tank valve 24b, the pressure adjusting valve 25b, and the INJ 26b.

The gas-liquid separator 27a and the drain valve 28a are provided on the exhaust pipe 22a in this order from the upstream side. The gas-liquid separator 27a separates water from the anode gas discharged from the FC 4a, and stores the water. The water stored in the gas-liquid separator 27a is discharged to the outside of the system 1 through the exhaust pipe 22a by opening of the drain valve 28a. The driving of the drain valve 28a is controlled by the ECU 2. The same applies to the gas-liquid separator 27b and the drain valve 28b.

The circulation pipe 23a is a pipeline for recirculating anode gas to the FC 4a, and is connected at an upstream end portion thereof to the gas-liquid separator 27a. The HP 29a is arranged in the circulation pipe 23a. The anode gas discharged from the FC 4a is appropriately pressurized by the HP 29a, and is introduced to the supply pipe 21a. The driving of the HP 29a is controlled by the ECU 2. The same applies to the circulation pipe 23b and the HP 29b.

The electric power control systems 30a, 30b include fuel cell DC/DC converters (hereinafter referred to as FDC's) 32a, 32b, battery DC/DC converters (hereinafter referred to as BDC's) 34a, 34b, and auxiliary inverters (hereinafter referred to as AINV's) 39a, 39b respectively. The electric power control systems 30a, 30b share a motor inverter (hereinafter referred to as an MINV) 38 that is connected to the motor 50. Each of the FDC's 32a, 32b adjusts direct current (DC) power from each of the FC's 4a, 4b, and outputs the adjusted DC power to the MINV 38. Each of the BDC's 34a, 34b adjusts DC power from each of the BAT's 8a, 8b, and outputs the adjusted DC power to the MINV 38. The electric power generated by each of the FC's 4a, 4b can be stored in each of the BAT's 8a, 8b. The MINV 38 converts the input DC power into three-phase alternating current (AC) power, and supplies this three-phase AC power to the motor 50. The motor 50 causes the vehicle to run by driving wheels 5.

The electric power of each of the FC 4a and the BAT 8a can be supplied to load devices other than the motor 50 via the AINV 39a. Similarly, the electric power of each of the FC 4b and the BAT 8b can be supplied to the load devices via the AINV 39b. It should be noted herein that the load devices include auxiliaries for the FC's 4a, 4b, and auxiliaries for the vehicle. The auxiliaries for the FC's 4a, 4b include the above-mentioned ACP's 14a, 14b, the above-mentioned bypass valves 15a, 15b, the above-mentioned back pressure valves 17a, 17b, the above-mentioned tank valves 24a, 24b, the above-mentioned pressure adjusting valves 25a, 25b, the above-mentioned INJ's 26a, 26b, the above-mentioned drain valves 28a, 28b, and the above-mentioned HP's 29a, 29b. The auxiliaries for the vehicle include, for example, an air-conditioning apparatus, an illuminating device, a hazard lamp, and the like.

The ECU 2 includes a central processing unit (a CPU), a read only memory (a ROM), and a random access memory (a RAM). An accelerator depression amount sensor 6, an ignition switch 7, the ACP's 14a, 14b, the bypass valves 15a, 15b, the back pressure valves 17a, 17b, the tank valves 24a, 24b, the pressure adjusting valves 25a, 25b, the INJ's 26a, 26b, the drain valves 28a, 28b, the FDC's 32a, 32b, and the BDC's 34a, 34b are electrically connected to the ECU 2. The ECU 2 calculates an output required of the FC's 4a, 4b as a whole, based on a detection value of the accelerator depression amount sensor 6. The ECU 2 controls the auxiliaries for the FC's 4a, 4b and the like such that the total electric power generated by the FC's 4a, 4b converges to the required output, and controls the amounts of anode gas and cathode gas supplied to each of the FC's 4a, 4b.

Scavenging Control

The ECU 2 performs scavenging control for carrying out scavenging by driving the ACP 14b and supplying cathode gas to a cathode gas flow passage in the FC 4b, so as to drain the liquid water remaining in the FC 4b with the FC 4b stopped from generating electric power. This is because of the following reason. When the system 1 stops with the liquid water remaining in the cathode gas flow passage in the FC 4b, the remaining liquid water freezes depending on the outside air temperature or the like. When the system 1 is activated afterward, the output performance of the FC 4b may deteriorate due to an increase in pressure loss of cathode gas. In the present embodiment, scavenging can be carried out by supplying cathode gas into the FC 4a by driving the ACP 14a. Accordingly, the ACP's 14a, 14b are examples of the scavenging device that can scavenge the FC's 4a, 4b independently of each other. The ECU 2 is an example of the control device that controls the ACP's 14a, 14b as the examples of the scavenging device. In the present embodiment, however, the ECU 2 scavenges only the FC 4b because of a difference in electric power generation volume that will be described below.

Electric Power Generation Volume

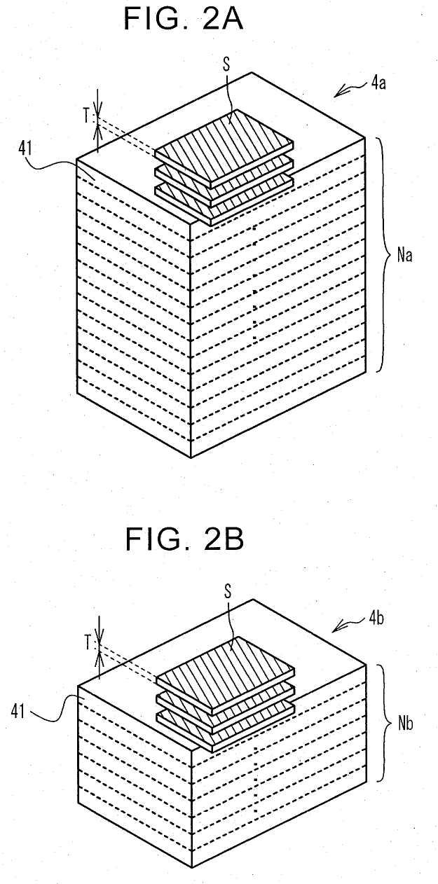

FIG. 2A is an illustrative view of the electric power generation volume of the FC 4a, and FIG. 2B is an illustrative view of the electric power generation volume of the FC 4b. Each of the FC's 4a, 4b is obtained by stacking a plurality of identical single cells 41. The electric power generation volume of the FC 4a is the sum of electric power generation volumes of the respective single cells 41 with which the FC 4a is equipped. Similarly, the electric power generation volume of the FC 4b is the sum of electric power generation volumes of the respective single cells 41 with which the FC 4b is equipped. The electric power generation volume of each of the single cells 41 is a value obtained by multiplying an electrode area S of each of the single cells 41 and an electrode thickness T of each of the single cells 41 by each other. The electrode area S is an area of a region where an electrolyte membrane overlaps with an anode catalyst layer and a cathode catalyst layer that are provided on one surface and the other surface of the electrolyte membrane respectively. The electrode thickness T is an average thickness of the region where the electrolyte membrane overlaps with the anode catalyst layer and the cathode catalyst layer. As shown in FIGS. 2A and 2B, the electric power generation volume of each of the single cells 41 is a value obtained by multiplying the electrode area S and the electrode thickness T by each other. It should be noted herein that the number of stacked single cells 41 in the FC 4a is Na, and that the number of stacked single cells 41 in the FC 4b is Nb, which is smaller than Na. Accordingly, the electric power generation volume of the FC 4a is a value obtained by multiplying the electrode area S, the electrode thickness T, and the number Na of single cells 41 by one another. The electric power generation volume of the FC 4b is a value obtained by multiplying the electrode area S, the electrode thickness T, and the number Nb of single cells 41 by one another.

As the above-mentioned electric power generation volume increases, the rated output also increases, the amount of liquid water generated in each of the fuel cells at the time of electric power generation also increases, and the amount of liquid water remaining in each of the fuel cells at the time of stoppage of the system also increases. As the electric power generation volume increases, the volume of a reaction gas flow passage in each of the fuel cells also increases. Accordingly, as the electric power generation volume increases, the amount of energy needed to sufficiently drain water through scavenging also increases, and the amount of necessary electric power also increases. In the present embodiment, the ECU 2 can sufficiently drain water from the FC 4b with a small amount of electric power consumption, by scavenging the FC 4b whose electric power generation volume is small, without scavenging the FC 4a whose electric power generation volume is large, as described above. Scavenging control will be described hereinafter in detail.

Details of Scavenging Control

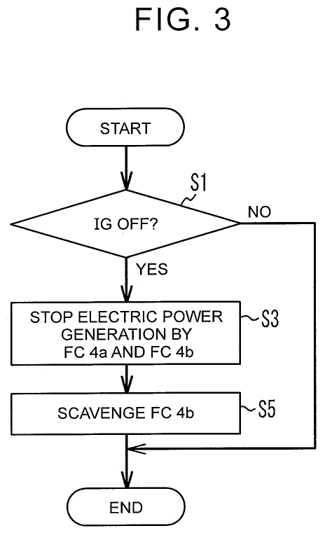

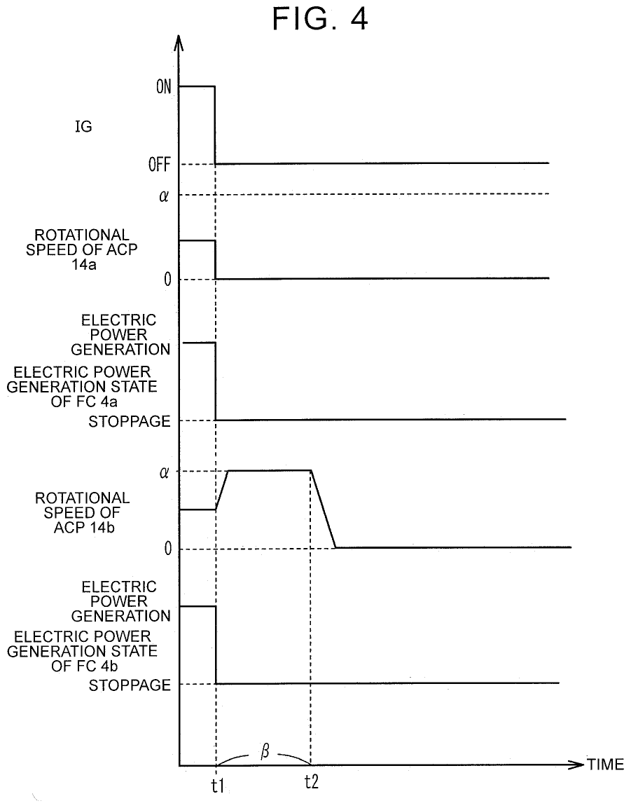

FIG. 3 is a flowchart showing an example of scavenging control. FIG. 4 is a timing chart showing the example of scavenging control. FIG. 4 shows changeover between ON and OFF states of an ignition, respective rotational speeds of the ACP's 14a, 14b, and electric power generation states of the FC's 4a, 4b. The present control is repeatedly performed at intervals of a predetermined period.

The ECU 2 determines, based on an output signal from the ignition switch 7, whether or not the OFF state of the ignition has been detected (step S1). If the result of step S1 is No, the present control is ended. If the OFF state of the ignition is detected (Yes in step S1), the ECU 2 stops electric power generation by the FC's 4a, 4b (step S3, at a timing t1). Specifically, the FC's 4a, 4b are electrically disconnected from the load devices by switches inside the FDC's 32a, 32b respectively. At the same time, the ECU 2 stops supplying anode gas and cathode gas to the FC 4a and supplying anode gas to the FC 4b, by closing the tank valves 24a, 24b and the pressure adjusting valves 25a, 25b and stopping the driving of the INJ's 26a, 26b and the ACP 14a.

Furthermore, the ECU 2 continues to drive the ACP 14b based on the electric power with which the BAT 8b is charged, and starts scavenging the FC 4b (step S5, at the timing t1). As a condition for scavenging the FC 4b, the rotational speed of the ACP 14b is set to a speed α suited for the scavenging of the FC 4b, and the scavenging period is set to a period β. The speed α is a speed that is higher than the rotational speed of the ACP 14b in the case where the electric power generated by the FC 4b is controlled in accordance with the required output. The speed α is, for example, 2000 rpm. The period β is, for example, 20 seconds. Thus, liquid water can be drained from a cathode flow passage in the FC 4b. The ECU 2 completes the scavenging of the FC 4b at a timing t2 upon the lapse of the period β from the start of the scavenging thereof. By thus performing scavenging control when the ignition is OFF, the output performance of the FC 4b can be ensured since activation of the system 1 as described above. The FC 4b is scavenged by the ACP 14b, with the state of communication between the supply pipe 11b and the bypass pipe 13b canceled by the bypass valve 15b, and with the back pressure valve 17b remaining open.

As described above, the ECU 2 scavenges the FC 4b, but does not scavenge the FC 4a whose electric power generation volume is larger than that of the FC 4b. Accordingly, in the present embodiment, the amount of electric power consumed through scavenging is smaller than in the case where the FC 4a whose electric power generation volume is large is sufficiently scavenged and the FC 4b whose electric power generation volume is small is not scavenged. Therefore, the summated electric power with which the BAT's 8a, 8b are charged can be ensured in the present embodiment. Accordingly, when the required output is large immediately after activation of the system 1, it is also possible to drive the motor 50 based on the electric power with which the BAT's 8a, 8b are charged in priority to the electric power generated by the FC's 4a, 4b. Thus, the acceleration responsiveness in starting the vehicle immediately after activation of the system 1 can be ensured. The ECU 2 may issue a command to scavenge only the FC 4a, or issue a command to scavenge both the FC 4a and the FC 4b, unless both the FC 4a and the FC 4b are stopped from generating electric power.

In addition, scavenging is carried out as to the FC 4b as described above. Therefore, in activating the system 1, electric power generation can be started early without taking into consideration the fact that there is liquid water remaining in the FC 4b. As shown in FIGS. 2A and 2B, the volume of the FC 4b is smaller than the volume of the FC 4a, and the amounts of cathode gas and anode gas that need to be supplied to ensure electric power generation by the FC 4b are also smaller than the amounts of cathode gas and anode gas that need to be supplied to ensure electric power generation by the FC 4a. Therefore, in activating the system 1, cathode gas and anode gas can be supplied in such a manner as to suit electric power generation by the FC 4b within a short period, and electric power generation by the FC 4b can be started early. Thus, the responsiveness of the output by the FC 4b can be ensured in activating the system 1.

In addition, as the electric power generation volume increases, the amount of scavenging gas needed to ensure sufficient drainage of water through scavenging also increases. Therefore, this required amount of scavenging gas is larger in the FC 4a than in the FC 4b. Accordingly, under the condition that the flow rate of scavenging gas supplied to the FC 4a and the flow rate of scavenging gas supplied to the FC 4b are equal to each other, the period to the completion of scavenging is shorter in the case where the FC 4b is scavenged and the FC 4a is not scavenged as in the present embodiment than in the case where the FC 4a is scavenged and the FC 4b is not scavenged. Thus, in the present embodiment, the scavenging of the FC 4b is completed, and the driving of the ACP 14b is stopped in a short period after the turning OFF of the ignition. Therefore, the period in which the ACP 14b continues to be driven after the turning OFF of the ignition is restrained from being prolonged, and the feeling of strangeness developed by a driver can be alleviated.

As described above, the volume of the FC 4b is smaller than the volume of the FC 4a, so the thermal capacity of the FC 4b is smaller than the thermal capacity of the

FC 4a. It should be noted herein that, for example, warm-up operation for generating electric power while raising the temperature of each of the fuel cells by increasing the thermal loss by making the stoichiometric ratio of cathode gas smaller than at the time of normal operation may be performed with a view to raising the temperature of each of the fuel cells to a temperature suited for electric power generation at an early stage, when the system 1 is in a low-temperature environment upon being activated. It should be noted herein that when the FC's 4a, 4b are caused to generate the same electric power under the same condition on the stoichiometric ratio of reaction gas and the like, the thermal loss is larger in the FC 4b whose electric power generation volume is small than in the FC 4a, due to the property of the fuel cells, and the amount of electric power generated by the FC 4b is hence likely to be larger than the amount of electric power generated by the FC 4a. Furthermore, the thermal capacity of the FC 4b is also smaller than the thermal capacity of the FC 4a. Therefore, even when the FC's 4a, 4b are caused to generate the same electric power, the temperature of the FC 4b is likely to rise to the temperature suited for electric power generation earlier than the temperature of the FC 4a. Therefore, when the system 1 is activated at low temperature, it is also possible to raise the temperature of the FC 4b early through warm-up operation, and the responsiveness of the output of the FC 4b can be ensured.

As described above, the temperature of the FC 4b can be raised by causing the FC 4b to generate electric power early in activating the system 1. Therefore, the raising of the temperature of the FC 4a may be promoted through the use of the heat of the FC 4b. For example, a coolant passage may be configured such that the coolant that has received heat from the FC 4b flows through the FC 4a before flowing through a radiator. In addition, the FC 4b may be in contact with the FC 4a directly or indirectly via a member exhibiting high thermal conductivity such as copper or the like, such that the heat generated by the FC 4b is transferred to the FC 4a. For example, the FC 4b may be in contact with a spot close to a region of the FC 4a in which liquid water is likely to freeze. At the same time, the heat of the auxiliaries for the FC 4b that has already generated electric power, for example, the ACP 14b and the like may be transferred to the FC 4a by holding these auxiliaries in contact with the FC 4a directly or indirectly.

In addition, electric power generation by the FC 4a may be started as soon as a certain amount of heat of the FC 4b is transferred to the FC 4a after the start of electric power generation by the FC 4b, in activating the system 1. Thus, when ice remains in the FC 4a in activating the system 1, the occurrence of problems such as hydrogen deficiency in the FC 4a and the like can be suppressed by melting the ice in the FC 4a through the use of the heat of the FC 4b and then starting electric power generation in the FC 4a.

Modification Example of Scavenging Control

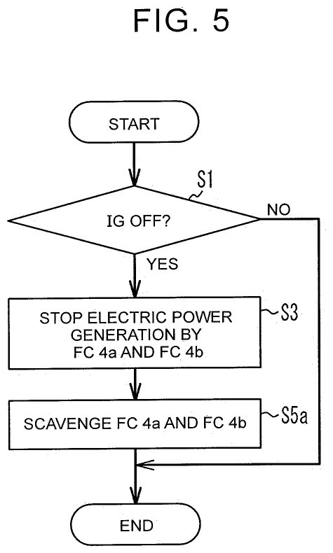

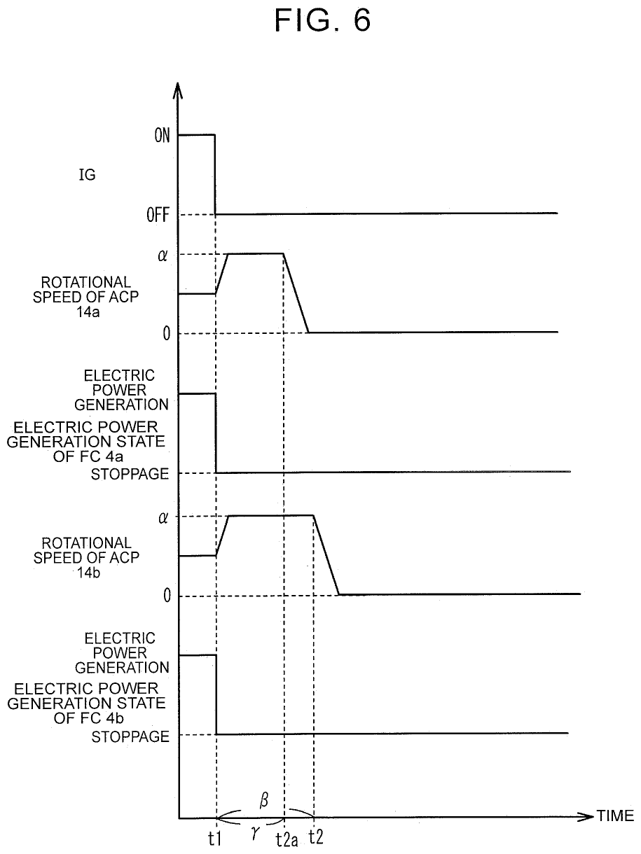

Next, a modification example of scavenging control will be described. FIG. 5 is a flowchart showing the modification example of scavenging control. FIG. 6 is a timing chart showing the modification example of scavenging control. Processing steps identical to those of the above-mentioned embodiment are denoted by the same reference symbols respectively, and redundant description thereof will be omitted.

If the result of step S1 is Yes and after the processing of step S3 is carried out, the ECU 2 scavenges both the FC's 4a, 4b (step S5a). Specifically, the scavenging of each of the FC's 4a, 4b is carried out based on the electric power with which each of the BAT's 8a, 8b is charged. The condition for scavenging the FC 4b is the same as described above. As a condition for scavenging the FC 4a, the rotational speed of the ACP 14a is equal to the speed α, and the scavenging period is set to a period γ shorter than the period β. The period γ is, for example, 10 seconds. Accordingly, the scavenging of the FC 4a is completed at a timing t2a, and then the scavenging of the FC 4b is then completed at the timing t2. The ECU 2 may issue a command to scavenge the FC 4a, but an ECU (not shown) that is different from the ECU 2 may issue a command to scavenge the FC 4a.

Thus, both the FC's 4a, 4b are scavenged, but the amount of electric power consumed by the ACP 14a through the scavenging of the FC 4a is smaller than the amount of electric power consumed by the ACP 14b through the scavenging of the FC 4b. Therefore, water can be sufficiently drained from the FC 4b while restraining the amount of electric power consumed through the scavenging of both the FC's 4a, 4b from increasing. In addition, the FC 4a is also slightly scavenged, so water can be drained from the FC 4a within such a range that the amount of electric power consumption does not become too large. As a result, the responsiveness of the output of the FC 4a in activating the system 1 can be enhanced.

Furthermore, the timing for starting scavenging the FC 4a and the timing for starting scavenging the FC 4b are substantially equal to each other. Therefore, the period from the timing when the ignition is turned OFF to the timing when both the ACP's 14a, 14b are stopped upon completion of the scavenging of both the FC's 4a, 4b is restrained from being prolonged. As a result, the feeling of strangeness developed by the driver due to the continuation of the driving of the ACP's 14a, 14b even after the turning OFF of the ignition is alleviated.

In the present modification example, the scavenging of the FC 4a and the scavenging of the FC 4b are substantially simultaneously started, but the disclosure is not limited thereto. From the standpoint of completing the scavenging of the FC's 4a, 4b within a short period, the scavenging of the FC 4a is desired to be started and completed while the FC 4b is scavenged.

In the aforementioned modification example, as the conditions for scavenging the FC's 4a, 4b, the rotational speed of the ACP 14a and the rotational speed of the ACP 14b are equal to each other, and the scavenging period of the FC 4a is shorter than the scavenging period of the FC 4b. Thus, the amount of electric power consumed through the scavenging of the FC 4a is made smaller than the amount of electric power consumed through the scavenging of the FC 4b, but the disclosure is not limited thereto. For example, the scavenging period of the FC 4a and the scavenging period of the FC 4b are equal to each other, but the amount of electric power consumed through the scavenging of the FC 4a may be made smaller than the amount of electric power consumed through the scavenging of the FC 4b, by making the rotational speed of the ACP 14a lower than the rotational speed of the ACP 14b. This is because, in any case, the amount of electric power consumed by scavenging the FC's 4a, 4b can be restrained from increasing while sufficiently draining water from the FC 4b.

In the aforementioned embodiment and the aforementioned modification example, the FC 4b having a smaller number of stacked single cells than the FC 4a is exemplified as the second fuel cell that is smaller in electric power generation volume than the first fuel cell, but the disclosure is not limited thereto. For example, the second fuel cell may be smaller in electric power generation volume than the first fuel cell, with the number of stacked single cells in the first fuel cell and the number of stacked single cells in the second fuel cell being equal to each other, and with the electrode area of each of the single cells in the second fuel cell being smaller than the electrode area of each of the single cells in the first fuel cell. Alternatively, the second fuel cell may be smaller in electric power generation volume than the first fuel cell, with the number of stacked single cells in the first fuel cell and the number of stacked single cells in the second fuel cell being equal to each other, and with the electrode area of each of the single cells in the first fuel cell and the electrode area of each of the single cells in the second fuel cell also being equal to each other, but with the electrode thickness of each of the single cells in the second fuel cell being smaller than the electrode thickness of each of the single cells in the first fuel cell.

Modification Example of System

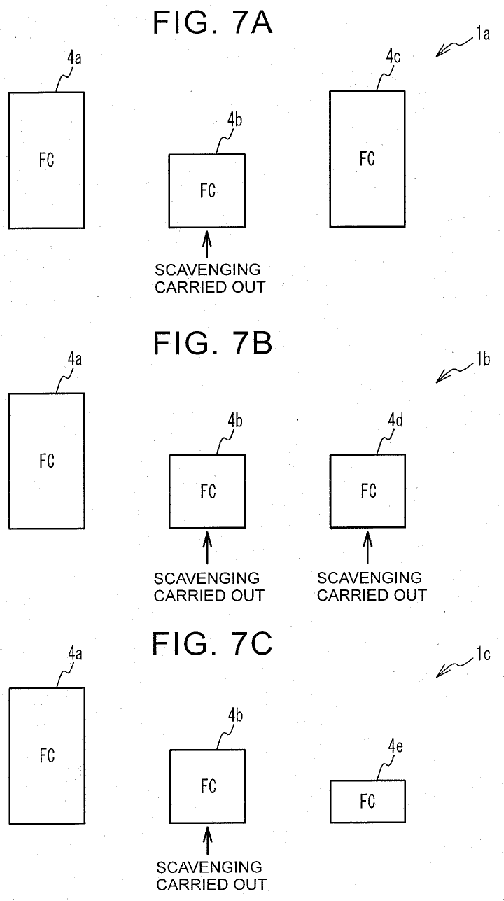

Next, scavenging control in a system that is equipped with three fuel cells will be described. Each of FIGS. 7A to 7C is a view showing three fuel cells adopted in a system. The other configurational details are omitted in FIGS. 7A to 7C.

A system 1a shown in FIG. 7A is equipped with an FC 4c that is larger in electric power generation volume than the FC 4b and that is equal in electric power generation volume to the FC 4a, in addition to the FC's 4a, 4b. In the system 1a, the FC 4b is scavenged, and the FC's 4a, 4c are not scavenged. The amount of electric power consumption can be held small by refraining from scavenging the FC's 4a, 4c that are larger in electric power generation volume than the FC 4b. The same applies to when the FC 4c is larger in electric power generation volume than the FC 4b and smaller in electric power generation volume than the FC 4a.

A system 1b shown in FIG. 7B is equipped with an FC 4d that is equal in electric power generation volume to the FC 4b, in addition to the FC's 4a, 4b. In this case, the FC's 4b, 4d are scavenged. The amount of electric power consumption can be held small by refraining from scavenging the FC 4a that is larger in electric power generation volume than each of the FC's 4b, 4d.

A system 1c shown in FIG. 7C is equipped with an FC 4e that is smaller in electric power generation volume than the FC 4b, in addition to the FC's 4a, 4b. In this case, the FC 4b is scavenged. The amount of electric power consumption can be held small by refraining from scavenging the FC's 4a, 4e.

In the modification examples shown in FIGS. 7A to 7C as well, the FC 4a and the FC 4c may be scavenged such that the amount of electric power consumed by scavenging each of the FC's 4a, 4c becomes smaller than the amount of electric power consumption of the FC 4b. In this case as well, the scavenging period of the FC 4b and the scavenging period of each of the FC's 4a, 4c are desired to at least partially overlap with each other.

### Other Modification Examples

In the aforementioned embodiment and the aforementioned modification examples, only the cathode side is scavenged. However, only the anode side may be scavenged, or both the cathode side and the anode side may be scavenged. In the case where the anode side is scavenged, the FC 4b may be scavenged by driving the HP 29b, using the anode gas remaining in the circulation pipe 23b as scavenging gas, and circulating this anode gas to the FC 4b, for example, after electric power generation by the FC 4b is stopped upon detection of the OFF state of the ignition. In this case, the amount of electric power consumed by driving the HP 29b after the stoppage of electric power generation by the FC 4b can be regarded as the amount of electric power consumed by scavenging the FC 4b. Each of the HP's 29a, 29b can be regarded as an example of the scavenging device that can scavenge each of the FC's 4a, 4b.

In the aforementioned embodiment and the aforementioned modification example, the anode gas supply systems 20a, 20b are equipped with the HP's 29a, 29b respectively, but the disclosure is not limited thereto. The anode gas supply systems 20a, 20b may be equipped with ejectors instead of the HP's 29a, 29b respectively. In the case where the anode side is scavenged in this configuration, the FC 4b may be scavenged by using the anode gas injected by the INJ 26b as scavenging gas, for example, after electric power generation by the FC 4b is stopped upon detection of the OFF state of the ignition. In this case, the amount of electric power consumed by driving the INJ 26b after the stoppage of electric power generation by the FC 4b may be regarded as the amount of electric power consumed by scavenging the FC 4b. Each of the INJ's 26a, 26b can be regarded as an example of the scavenging device capable of scavenging each of the FC's 4a, 4b.

In the aforementioned embodiment and the aforementioned modification example, scavenging is carried out when the ignition is OFF. However, scavenging may be carried out before detecting the ON state of the ignition and starting electric power generation by the FC's 4a, 4b.

In the aforementioned embodiment, the BAT's 8a, 8b corresponding to the FC's 4a, 4b respectively are provided, but the disclosure is not limited thereto. A secondary battery that is connected to both the FC's 4a, 4b may be provided. In the aforementioned embodiment, the tanks 20Ta, 20Tb corresponding to the FC's 4a, 4b respectively are provided, but the disclosure is not limited thereto. A tank that is used for both the FC's 4a, 4b may be provided instead of the tanks 20Ta, 20Tb. Alternatively, three or more tanks may be provided.

The vehicle that is mounted with the fuel cell system may not necessarily be an automobile, but may be a two-wheeled vehicle, a railroad vehicle, a ship, an airplane or the like. This vehicle may also be a hybrid vehicle that can be driven through the use of both a motor and an internal combustion engine.

Although the preferred embodiment of the disclosure has been described above in detail, the disclosure is not limited to this specific embodiment thereof. The disclosure can be subjected to various modifications and alterations within the scope of the gist of the disclosure set forth in the claims.

What is claimed is:

1. A fuel cell system comprising:
a first fuel cell and a second fuel cell;
a scavenging device that can scavenge the first fuel cell and the second fuel cell independently of each other; and
a control device configured to control the scavenging device, wherein
an electric power generation volume of the second fuel cell is smaller than an electric power generation volume of the first fuel cell, and
the control device is configured to scavenge the second fuel cell.

2. The fuel cell system according to claim 1, wherein the control device is not configured to scavenge the first fuel cell.

3. The fuel cell system according to claim 1, wherein the control device is configured to scavenge the first fuel cell with an amount of electric power consumption that is smaller than an amount of electric power consumed by scavenging the second fuel cell.

4. The fuel cell system according to claim 3, wherein the control device is configured to scavenge the first fuel cell and the second fuel cell such that a scavenging period of the first fuel cell and a scavenging period of the second fuel cell at least partially overlap with each other.

5. The fuel cell system according to claim 3, wherein the control device is configured to start and complete scavenging of the first fuel cell in a period in which scavenging of the second fuel cell is carried out.

6. The fuel cell system according to claim 1, further comprising:
a third fuel cell with an electric power generation volume that is larger than the electric power generation volume of the second fuel cell, wherein
the scavenging device can scavenge the first fuel cell, the second fuel cell, and the third fuel cell independently of one another, and
the control device is not configured to scavenge the third fuel cell.

7. The fuel cell system according to claim 1, further comprising:
a third fuel cell with an electric power generation volume that is equal to the electric power generation volume of the second fuel cell, wherein
the scavenging device can scavenge the first fuel cell, the second fuel cell, and the third fuel cell independently of one another, and
the control device is configured to scavenge the third fuel cell.

8. The fuel cell system according to claim 1, further comprising:
a third fuel cell with an electric power generation volume that is smaller than the electric power generation volume of the second fuel cell, wherein
the scavenging device can scavenge the first fuel cell, the second fuel cell, and the third fuel cell independently of one another, and
the control device is not configured to scavenge the third fuel cell.

9. The fuel cell system according to claim 1, wherein
each of the first fuel cell and the second fuel cell is equipped with a plurality of single cells,
an electric power generation volume of each of the single cells is a value obtained by multiplying an electric power generation area of each of the single cells and an electrode thickness of each of the single cells by each other,
the electric power generation volume of the first fuel cell is a sum of electric power generation volumes of the plurality of the single cells with which the first fuel cell is equipped, and
the electric power generation volume of the second fuel cell is a sum of electric power generation volumes of the plurality of the single cells with which the second fuel cell is equipped.

10. The fuel cell system according to claim 1, wherein the control device is configured to scavenge only the second fuel cell in stopping electric power generation by the first fuel cell and the second fuel cell.
